(19) United States
(12) Patent Application Publication
(10) Pub. No.: US 2006/0257186 A1
(43) Pub. Date: Nov. 16, 2006

(54) Method for managing transaction document and system therefor

(75) Inventor: Mikio Beppu, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD.

(21) Appl. No.: 11/403,919

(22) Filed: Apr. 14, 2006

(30) Foreign Application Priority Data
Apr. 19, 2005 (JP) P2005-120764

(51) Int. Cl. B41J 5/30

(52) U.S. Cl. 400/62

(57) ABSTRACT

A method for managing a transaction document includes: reading the transaction document to which transaction number is attached; extracting the transaction number from the read transaction document; and judging whether or not the read transaction document is valid, on a basis of the extracted transaction number.

### CROSS-REFERENCE TO RELATED APPLICATION

The entire disclosure of Japanese Patent Application. No. 2005-120764 filed on Apr. 19, 2005, including the specification, claims, drawings and abstract is incorporated herein by reference in its entirety.

### BACKGROUND OF THE INVENTION

1. Field of the Invention

The invention relates to a method and a system for managing documents necessary for transactions (hereinafter referred to as “transaction documents”) such as bills, delivery slips, securities, special invoice & receipt (i.e., evidences of business transaction), or banknotes.

2. Description of the Related Art

Conventionally, a system for electronically generating transaction documents, which have been issued by printing on paper sheets, and performing transactions by exchanging electronic information between sellers and buyers has been conceived. For example, WO 00/38095 discloses the configuration in which a starting document including request information relating to a transaction activity is electrically received, some of the request information in the received starting document is mapped on a database, and transaction documents are automatically generated using the request information included in the database.

### SUMMARY OF THE INVENTION

However, transaction documents such as bills are still exchanged between sellers and buyers as paper-based transactions. In consideration of such a fact, it is hard to digitize everything. Also, according to a related art, when paper-based transaction documents are used, whether a transaction document is valid or invalid cannot be judged, and thus it is hard to maintain an appropriate transaction system.

Te invention provides a method of and a system for managing transaction documents, which can achieve digitization and maintain itself appropriately while allowing paper-based exchanges of the transaction documents.

According to an aspect of the invention, a method for managing a transaction document includes: reading the transaction document to which transaction number is attached; extracting the transaction number from the read transaction document; and judging whether or not the read transaction document is valid, on a basis of the extracted transaction number.

According to another aspect of the invention, a transaction document managing system includes a reading unit, an extracting unit and a judging unit. The reading unit reads a transaction document to which transaction number is attached. The extracting unit extracts the transaction number from the transaction document read by the reading unit. The judging unit judges whether or not the read transaction document is valid, on a basis of the extracted transaction number.

According to a still another aspect of the invention, a transaction document managing system includes a branch office and a center. The branch office includes a scanner section and a first computer. The center includes a second computer. The first computer, the scanner section, and the second computer are connected to each other via a network. The scanner section reads a transaction document to which transaction number is attached, to generate image data of the transaction document. The first computer includes an extracting unit and a judging unit. The extracting unit extracts transaction number from the image data of the transaction document. The judging unit compares the transaction number extracted by the extracting unit with transaction number generated by the second computer to judge whether or not the read transaction document is valid.

According to the above configuration, it can be confirmed easily whether each transaction document is true or false.

### BRIEF DESCRIPTION OF THE DRAWINGS

FIG. 1 is a block diagram schematically showing a transaction document managing system according to an embodiment of the invention.

FIG. 2 is a block diagram showing a software configuration in a computer of a center in the transaction document managing system according to the embodiment of the invention.

FIG. 3 is a flowchart showing a procedure of issuing transaction number by the computer of the center in the transaction document managing system according to the embodiment of the invention.

FIG. 4 is a block diagram showing a software configuration in a user's computer in the transaction document managing system according to the embodiment of the invention.

FIG. 5 is a flowchart showing a procedure of generating the transaction document by the user's computer in the transaction document managing system according to the embodiment of the invention.

FIG. 6 is a plan view showing an example of the transaction document in the transaction document managing system according to the embodiment of the invention.

FIG. 7 is a block diagram showing a software configuration in a computer of a branch office in the transaction document managing system according to the embodiment of the invention.

FIG. 8 is a flowchart showing a procedure of judging authenticity of the transaction document by the computer of the branch office in the transaction document managing system according to the embodiment of the invention.

FIG. 9 is a flowchart showing details of a procedure of judging whether or not the transaction number is valid by the computer of the branch office in the transaction document managing system according to the embodiment of the invention

FIG. 10 is a flowchart showing a procedure of processing transaction document data sent from the branch office to the center, in the transaction document managing system according to the embodiment of the invention.

FIG. 11 is an explanatory diagram showing file configurations of a database and a storage device in the transaction document managing system according to the embodiment of the invention.

### DETAILED DESCRIPTION OF EMBODIMENTS OF THE INVENTION

Embodiments of the invention will now be explained with reference to the accompanying drawings.

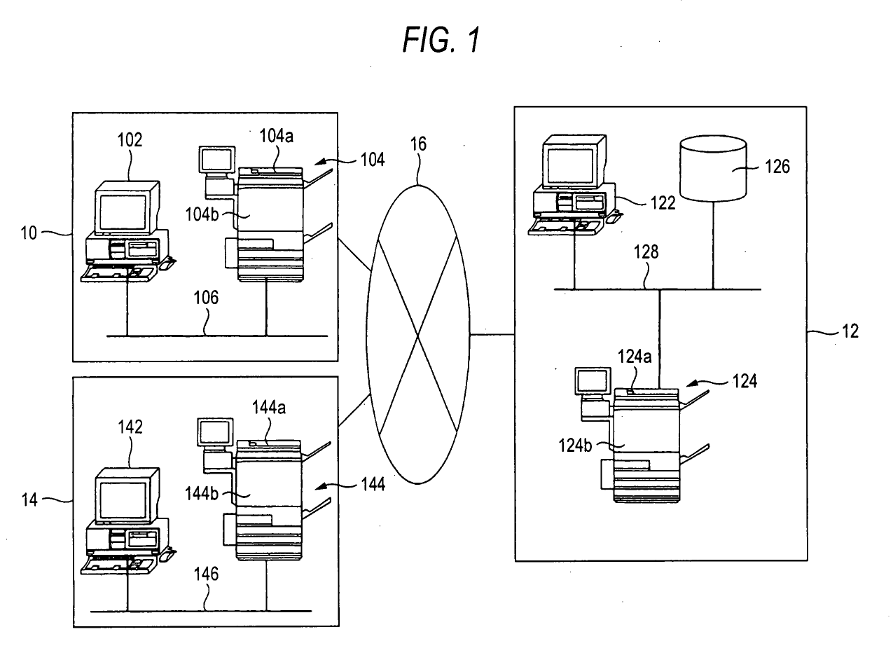

FIG. 1 schematically shows a transaction document managing system according to an embodiment of the invention. A large number of users 10 authenticated by the government or public organizations, a center 12 as the government or the public organizations and branch offices 14 thereof have relations to the transaction document managing system. The users 10 are sellers or buyers of goods or services. Each of the users 10 has a computer 102 and a multifunction device 104, which are connected to each other via a local area network (LAN) 106. The center 12 has a computer 122 such as a mainframe, a multifunction device 124, and a storage device 126, which are connected to each other via a LAN 128. Each of the branch offices 14 has a computer 142 and a multifunction device 144, which are connected to each other via a LAN 146. Further, the users 10, the center 12, and the branch offices 14 are connected to each other via the Internet 16.

The multifunction devices 104, 124, and 144 have scanner sections 104a, 124a, and 144a and printer sections 104b, 124b, and 144b, respectively. Each of the scanner sections 104a, 124a, and 144a has a document feeder, and reads the contents of the transaction documents printed thereon as described later. Each of the printer sections 104b, 124b, and 144b has a printing function for printing data output from respective one of the computers 102, 122, and 142 on the paper, as well as a copying function for making a copy of the documents read by respective one of the scanner sections 104a, 124a, and 144a. Here, the multifunction devices are described as an example of the scanner. Alternatively, a mere scanner (only having a scanning function) may be used in place of the multifunction device.

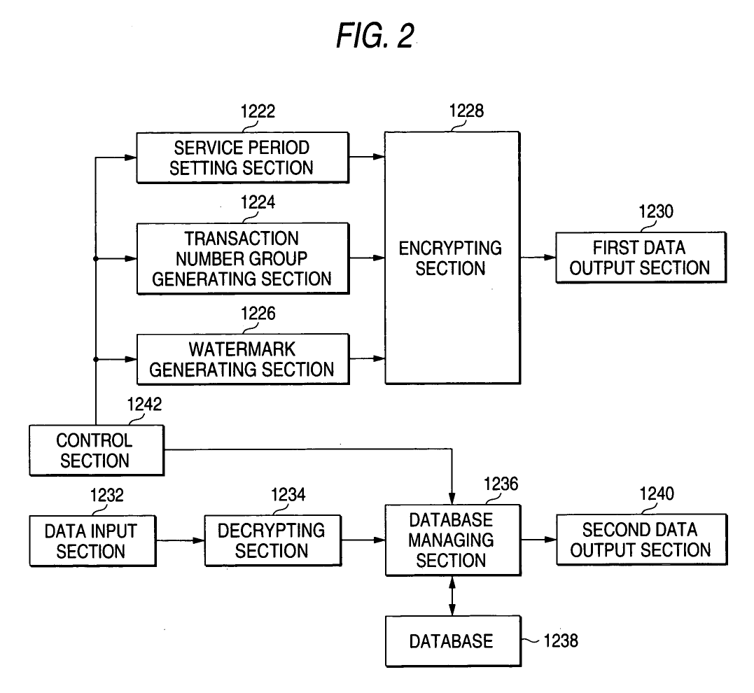

FIG. 2 shows a software configuration in the computer 122 of the center 12. A service period setting section 1222 sets a service period of transaction number and a watermark (electronic watermark) to be attached to a transaction document. A transaction number group generating section 1224 generates a group of transaction numbers to be attached to transaction documents. A watermark generating section 1226 generates a watermark, which is code information to be attached to a transaction document and is invisibly printed thereon. An encryption section 12228 encrypts the service period set by the service period setting section 1222, the group of the transaction numbers generated by the transaction number group generating section 1224 and the watermark generated by the watermark generating section 1226 a first data output section 1230 outputs the encrypted service period, the group of the encrypted transaction numbers and the encrypted watermark to the users 10 and the branch offices 14 via the Internet 16. Also, data input from the branch offices 14 via the Internet 16 and/or data read by the multifunction device 124 are input to the data input section 1232. If the data input to the data input section 1232 is encrypted, a decrypting section 1234 decrypts such encrypted data, and then the decrypted data is sent to a database managing section 1236. The database managing section 1236 manages a database 1238 and registers in the database 1238 the data input from the data input section 1232. Also, the database managing section 1236 associates transaction document data with the transaction numbers using the transaction numbers registered in the database managing section 1236 as keys, and a second data output section outputs the transaction document data to the storage device 126, to thereby store the transaction document data associated with the transaction numbers in the storage device 126. A control section 1242 controls the service period setting section 1222, the transaction number group generating section 1224, the watermark generating section 1226, and the database managing section 1236.

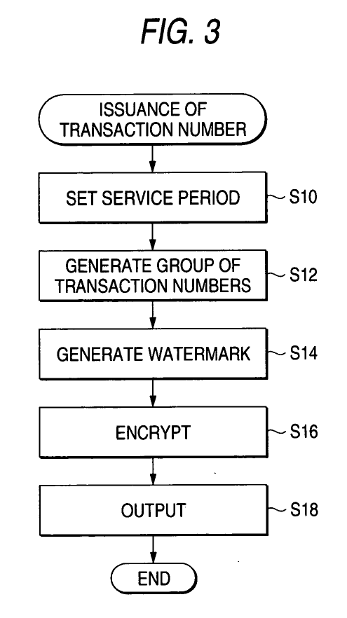

FIG. 3 shows a procedure of issuing the transaction numbers by the computer 122 of the center 12. In order to issue the transaction numbers, at first, the service period setting section 1222 sets the service period of the group of the transaction numbers at the step S10. The service period is, for example, 90 days. When the transaction number and the watermark are attached to the transaction document in this period, the transaction document is validated. At the succeeding step S12, the transaction number group generation section 1224 generates the group of the transaction numbers. The transaction number group may consist of consecutive numbers, or numbers generated at random using, for example, random numbers. At the following step S14, the watermark generating section 1226 generates the watermark. The watermark generated by the watermark generating section 1226 may be changed in accordance with the service period set by the service period setting section 1222, or kept unchanged. At the subsequent step S16, the encrypting section 1228 encrypts the service period, the group of the transaction numbers, and the watermark. The encryption can be executed using the Public Key Infrastructure (PKI). At the step S18, the first data output section 1230 outputs the encrypted data of the service period, the group of the transaction numbers and the watermark.

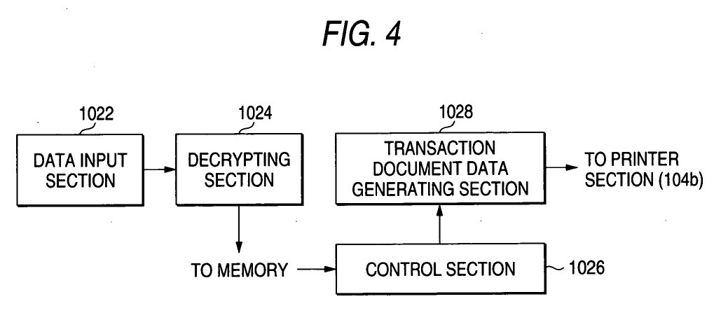

FIG. 4 shows a software configuration in each of the computers 102 of the users 10. The encrypted data of the service period, the group of the transaction numbers group, and the watermark sent from the computer 122 of the center 12 via the Internet 16 are input to the data input section 1022, decrypted by the decrypting section 1024, and stored in a memory of the computer 102. The control section 1026 reads out the transaction number and the watermark stored in the memory, passes the read data to a transaction document data generating section 1028 and causes the printer section 104b to generate the transaction document conforming to a predetermined format.

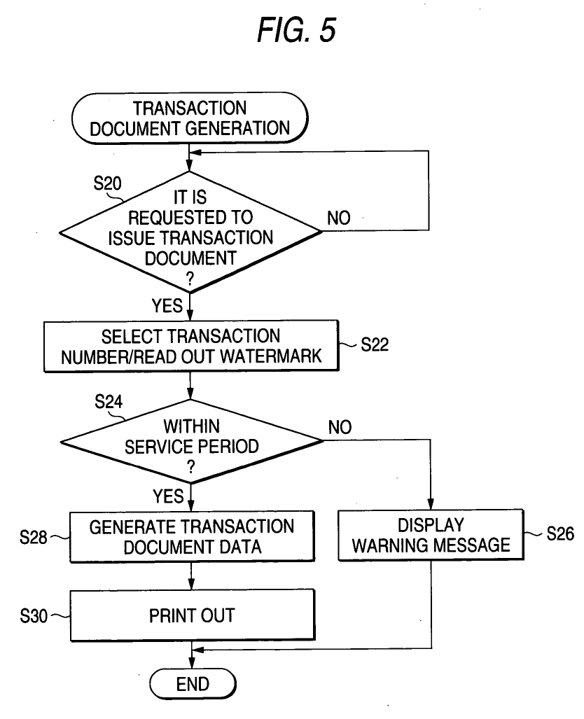

FIG. 5 shows a procedure of issuing the transaction document by each of the computers 102 of the users 10. In order to generating a transaction document, the computer 102 firstly judges whether or not generation of a transaction document is requested, at the step S20. If the computer 102 judges that generation of a transaction document has been requested, the procedure proceeds to the step S22. If not, a standby state continues until generation of a transaction document is requested. At the step S22, the computer 102 selects the transaction number from the group of the transaction numbers stored in the memory, and also reads out the watermark. At the succeeding step S24, the computer 102 judges whether or not date of generating the transaction document is within the service period set by the center 12. If the computer 102 judges that the date of generating the transaction document is not within the service period, since the transaction number and the watermark cannot be used, the procedure proceeds to the step S26. Then, the computer 102 displays warning message that the transaction document cannot be generated, and terminates the procedure. Meanwhile, if the computer 102 judges that the date of generating the transaction document is within the service period at the step 524, the procedure proceeds to the step S28 to generate transaction document data by the transaction document data generating section 1028. At the next step S30, the transaction document data is sent to the printer section 104b. Then, the printer section 104b prints the transaction document.

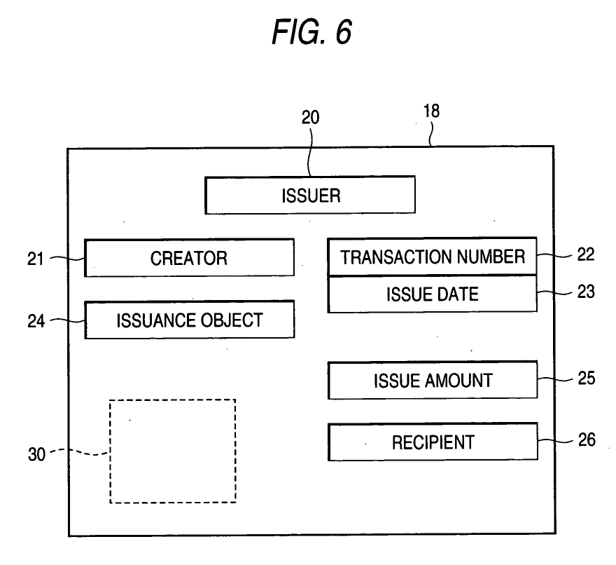

FIG. 6 shows an example of a transaction document 18 printed by the printer section 104b. The transaction document 18 is, for example, a special invoice & receipt (i.e., evidences of business transaction), and an issuer 20 (in this embodiment, the issuer is the center 12), a creator (a seller) 21, a transaction number 22, issue date 23, an issuance object (e.g., a name of goods or a name of a service) 24, issue amount 25 and a recipient (a buyer) 26 are printed thereon. Also, the watermark 30 is provided in a predetermined area of the transaction document 18. Such a transaction document 18 is delivered from the seller to the buyer when the seller provides the buyer with goods or services.

With respect to the transaction document thus generated, the buyer asks the branch office 14 to authenticate the delivered transaction document 18. The authentication of the transaction document 18 is carried out by reading the transaction document 18 with the scanner section 144a of the multifunction device 144 of the branch office 14, and then processing the data read out by the scanner 144a with the computer 142.

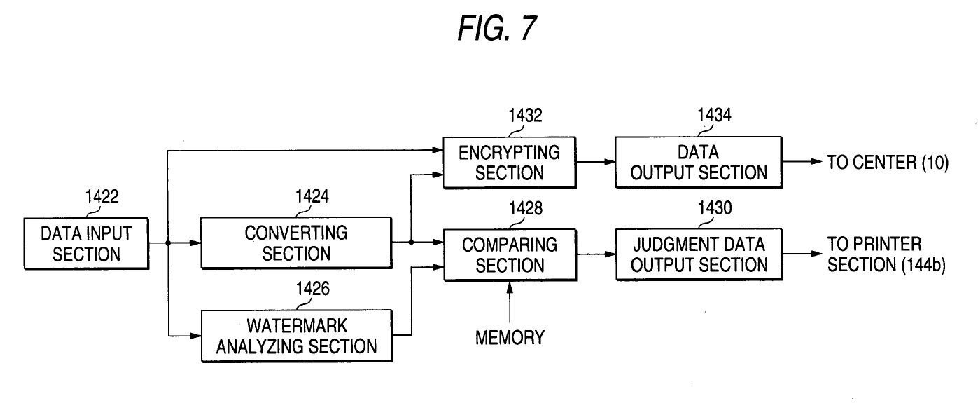

FIG. 7 shows a software configuration in each of the computers 142 of the branch offices 14. Image data read out by the scanner section 144a is input to a data input section 1422. A converting section 1424 converts the image data input to the data input section 1422, into character data. The converting section 1424 converts image data into character data by comparing the image data with dictionary data stored in the memory. Namely, the converting section 1424 extracts from the transaction document 18 the issuer data, the creator data, the transaction number data, the issue date data, the issuance object data, the issue amount data and the recipient data. Also, a watermark analyzing section 1426 analyzes the image data input to the data input section 1422. A comparing section 1428 compares the data extracted from the transaction document 18 or the data obtained by analyzing the transaction document 18 with data, which has previously been sent from the center 12 and stored in the memory. Authenticity of the transaction document is judged in accordance with the comparison result of the comparing section 1428. The judgment data regarding the authenticity is sent from a judgment data output section 1430 to the printer section 144b of the multifunction device 144. Further, the image data input to the data input section 1422 and the character data obtained by the conversion with the converting section 1424 are input into an encrypting section 1432 as a single file. The encrypting section 1432 encrypts the input data. The encrypted data is output from a data output section 1434 to the computer 122 of the center 12 via the Internet 16. It is noted that what is read by the scanner 144a is not only the transaction document 18 as the special invoice & receipt described above. Evidential documents such as an estimation sheet, a contract document and a delivery slip are also read in combination therewith, and sent to the computer 122 of the center 12 as a single file.

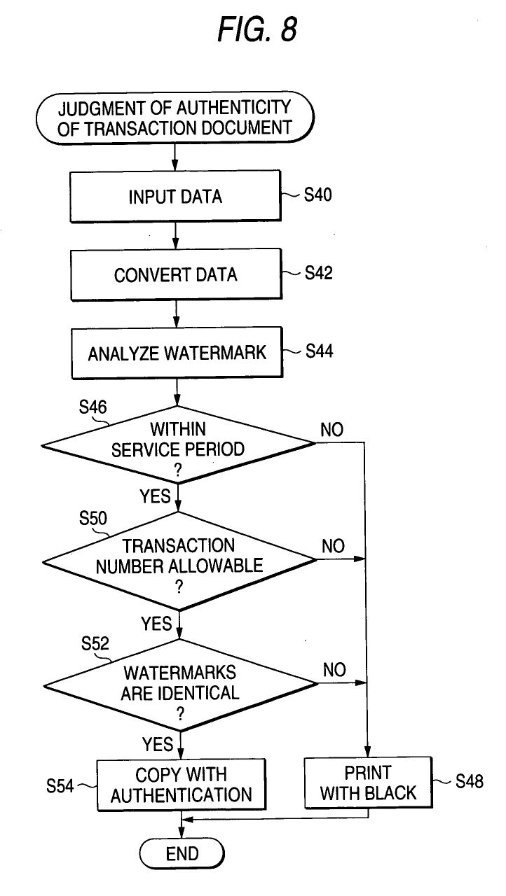

FIG. 8 shows a procedure of judging the authenticity of a transaction document by the computer 142 of the branch office 14. In order to judge the authenticity of the transaction document, at first the scanner section 144a reads the transaction document at the step S40. Image data read out therefrom is input to the data input section 1422. At the succeeding step S42, the converting section 1424 converts the read image data into character data to extract the issue date and the transaction number therefrom. At the subsequent step S44, the watermark read out at the step S40 is analyzed. At the next step S46, the read issue date data is compared with the service period stored in the memory to judge whether or not the issue data is within the service period. If at the step S46 the computer 142 judges that the issue data is not within the service period, the procedure proceeds to the step S48 to output, for example, a sheet printed with black by the printer section 144b, and then the computer 142 terminates the procedure. Meanwhile, if an the step S46 the computer 142 judges that the issue date is within the service period, the procedure proceeds to the succeeding step S50. The computer 142 judges whether or not the read transaction number is valid. If at the step S50 the computer 142 judges that the transaction number is invalid, the procedure proceeds to the step S48 to output, for example, a sheet printed with black, and the computer 142 terminates the procedure. Meanwhile, if at the step S50 the computer 142 judges that the transaction number is valid, the procedure proceeds to the step S52. The computer 142 judges whether or not the watermark obtained by analyzing the transaction document is identical to the watermark stored in the memory. If at the step S52 the computer 142 judges that the watermarks are not identical to each other, the procedure proceeds to the step S48 to output, for example, a sheet printed with black in the printer section 144b, and the computer 142 terminates the procedure. Meanwhile, if at the step S52 the computer 142 judges that the watermarks are identical to each other, the procedure proceeds to the succeeding step S54 to output a copy of the transaction document with authentication attached thereto from the printer section 144b, and the computer 142 terminates the procedure.

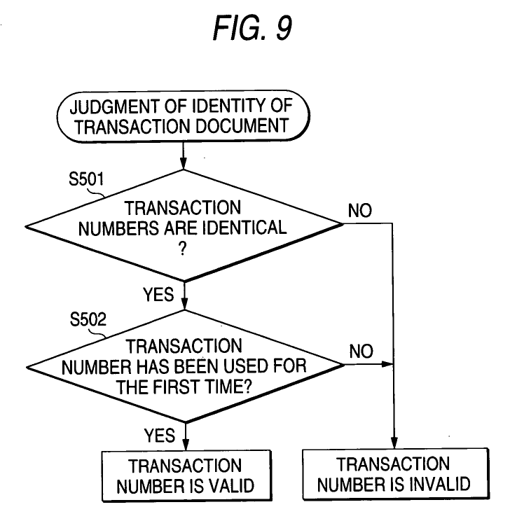

FIG. 9 shows details of step S50 for judging whether or not the transaction number is valid. That is, at step S501, the computer 142 firstly judges whether or not the transaction number extracted at step S42 is identical to any of the group of the transaction numbers previously sent from the center 12 and stored in the memory. At this step S501, if the computer 142 judges that the transaction number is identical, the procedure proceeds to step S502. Then, the computer 142 judges whether or not the transaction number extracted at step S42 has been used for the first time within the service period, that is, whether or not the extracted transaction number has been used doubly. At this step S502, if the computer 142 judges that the transaction number has been used for the first time, the computer 142 judges that the transaction number is valid. On the other hand, if the computer 142 judges that the transaction number is not identical at step S501 or that the transaction has already been used at step S502, the computer 142 judges that the transaction number is invalid.

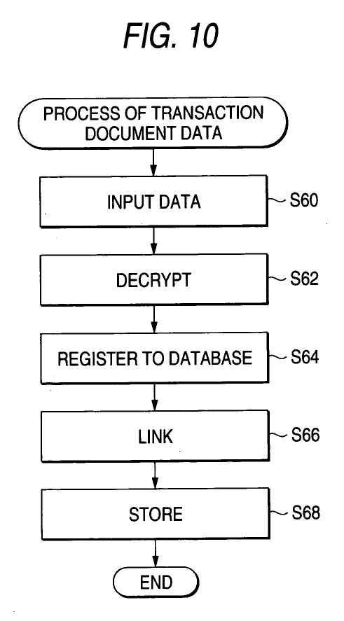

FIG. 10 shows a procedure of processing the transaction document data sent from the branch office 14 to the center 12. It is noted that the software configuration in the computer 122 of the center 12 is shown in FIG. 2. In order to process the transaction document data, the transaction document data (including the image data and the character data) sent from the branch office 14 is firstly input to the data input section 1232 at the step S60. At the succeeding step S62, the decrypting section 1234 decrypts the encrypted transaction document data, and then the decrypted transaction document data is sent to the database managing section 1236. At the subsequent step S64, the character data (e.g., the creator data, the transaction number data, the issue date data, the issuance object data, the issue amount data, and the recipient data) of the transaction document is input and registered in a field of the database 1238 previously prepared by the database managing section 1236. At the next step S66, the image data of the transaction documents is associated with the transaction numbers using the transaction numbers registered in the database 1238 as the keys. Also, at the succeeding step S68, the image data of the transaction documents are output from the data output section 1240 to the storage device 126 to store the image data of the transaction documents associated with the transaction numbers in the storage device 126.

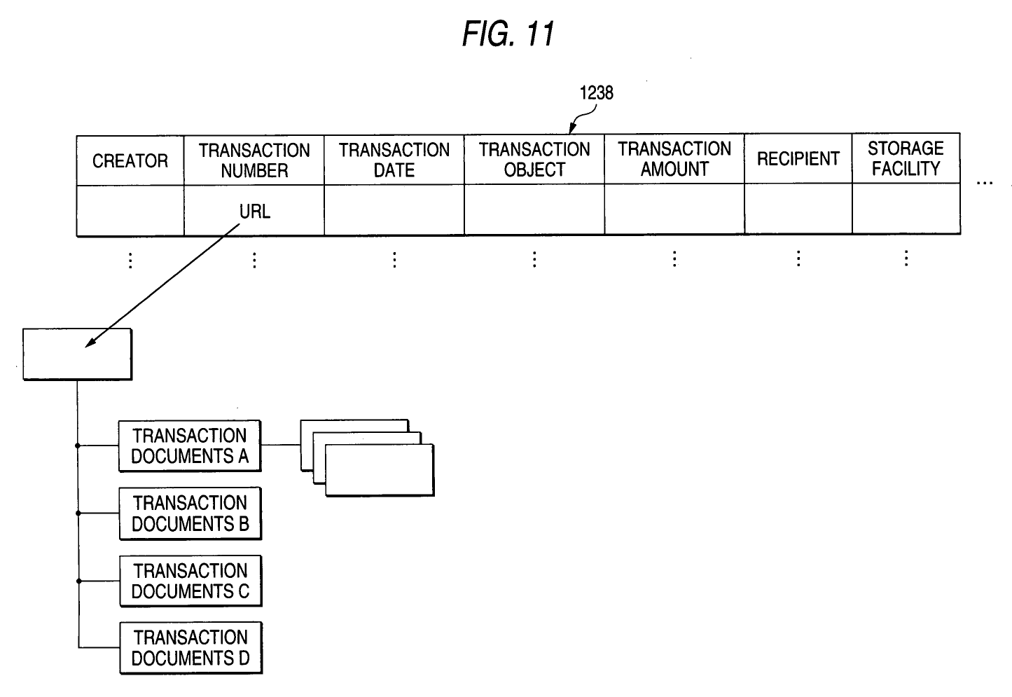

FIG. 11 shows file configurations of the database 1238 and the storage device 126. The database 1238 has a list form structure including an item of a storage facility of the paper-based transaction document such as storehouse number in addition to items such as the creator (the seller), the transaction number, the issue date, the issuance object, the issue amount and the recipient (the buyer). The paper-based transaction documents may include originals of an estimation sheet, a contract document, a delivery slip and an authenticated special invoice & receipt. Further, the storage facility information is manually input to and registered in the database 1238. In this case, as the transaction number, the storage location of the transaction document data is embedded in, for example, a form of the uniform resource locator (URL). The transaction document data stored in the storage device 126 is stored and managed hierarchically as shown in FIG. 10. Therefore, it is possible to access a required transaction document by tracing the hierarchical structure of the transaction documents stored in the storage device 126 using the transaction number as a link source anchor. It is noted that the access authority for accessing a transaction document can be set separately for every transaction document.

The whole of the transaction document managing system described above will now be explained in a lump.

In FIG. 1, the center 12 has authority for issuing the transaction document, sets the service period of the transaction document, and generates the transaction number and the watermark. The transaction number and the watermark generated in the center 12 are attached to the format of the transaction document by the printer section 104b of the multifunction device 104 of the previously authenticated user 10, thereby generating the transaction document. The transaction document is delivered from the seller to the buyer. The buyer who received the transaction document comes up to the branch office 14 of the government or the public organizations for asking for authentication of the transaction document. The multifunction device 144 is used for the authentication of the transaction document, and the transaction document is read by the scanner section 144a of the multifunction device 144. The issue date, the transaction number, and the watermark are extracted from the transaction document read by the scanner section 144a, and by comparing these with those issued from the center 12, the authenticity of the transaction document can be judged. If the transaction document is valid, a copy of the transaction document attached with the authentication is output from the printer section 144b, and if the transaction document is not valid, for example, a sheet printed by black is output. The transaction document data read out therefrom with the scanner section 144a is sent to the computer 122 of the center 12 with other transaction document data. The computer 122 of the center 12 links the transaction documents using the transaction number as the key and stores them in the storage device 126. As described above, since the transaction document data is stored in the storage device 126 while being linked using the transaction number as the key, the load of the computer 122 in the center 12 for the memory can be eased. Further, in the users 10 and the branch offices 14, the transaction document data can be retrieved by accessing the database of the center 12 via the Internet 16.

It is noted that, although in the embodiment described above, it is arranged that the transaction documents are read in a lump in the branch office 14, the invention is not limited to this arrangement, and the transaction documents can be read with other scanner sections in a distributed manner. Further, although in the embodiment described above, it is arranged that the transaction document data is stored in a lamp in the storage device 126 of the center 12, the invention is not limited to such an arrangement, and for example, the transaction document data can be stored in other storage devices in a distributed manner. Still further, although in the embodiment described above, the authenticity of the transaction document is judged in accordance with the transaction number and so on sent from the center 12 to the branch office 14, the invention is not limited to such an arrangement, and the encrypted transaction document data can be communicated between the center 12 and the branch office 14 every time the transaction document is read, and the authenticity can be judged by the computer 122 of the center 12.

As described above, the present invention can be applied to a system for managing transaction documents issued in paper forms.

Examples of the above described embodiment will be described below.

A method for managing a transaction document may include reading the transaction document to which transaction number is attached; extracting the transaction number from the read transaction document; and judging whether or not the read transaction document is valid, on a basis of the extracted transaction number.

Also, the reading may include reading the transaction document by a scanner as an image. The extracting may include converting data read by the scanner as the image, into character data to extract the transaction number.

Also, the judging may include comparing the extracted transaction number with a transaction number stored previously.

Also, the judging may be executed based on whether or not the extracted transaction number is identical to the transaction number stored previously.

Also, the judging may be executed based on whether or not the extracted transaction number has been used for the first time.

A transaction document managing system may include a reading unit, an extracting unit and judging unit. The reading unit reads a transaction document to which transaction number is attached. The extracting unit extracts the transaction number from the transaction document read by the reading unit. The judging unit judges whether or not the read transaction document is valid, on a basis of the extracted transaction number.

Also, the reading unit may include a scanner section that reads the transaction document as an image. The extracting unit may convert data read by the scanner section, into character data to extract the transaction number.

Also, the judging unit may include a comparing unit that compares the extracted transaction number with a transaction number stored previously.

Also, the comparing unit may include an identity judging unit that judges whether or not the extracted transaction number is identical to the transaction number stored previously.

Also, the comparing unit may includea first-time judging unit that judges whether or not the extracted transaction number has been used for the first time.

A transaction document managing system may include a branch office and a center. The branch office may include a scanner section and a first computer. The center may include a second computer. The first computer, the scanner section, and the second computer may be connected to each other via a network. The scanner section may read a transaction document to which transaction number is attached, to generate image data of the transaction document. The first computer may include an extracting unit and a judging unit. The extracting unit may extract transaction number from the image data of the transaction document. The judging unit may compare the transaction number extracted by the extracting unit with transaction number generated by the second computer to judge whether or not the read transaction document is valid.

What is claimed is:

1. A method for managing a transaction document, the method comprising:
reading the transaction document to which transaction number is attached;
extracting the transaction number from the read transaction document; and
judging whether or not the read transaction document is valid, on a basis of the extracted transaction number.

2. The method according to claim 1, wherein:
the reading comprises reading the transaction document by a scanner as an image, and
the extracting comprises converting data read by the scanner as the image, into character data to extract the transaction number.

3. The method according to claim 1, wherein the judging comprises comparing the extracted transaction number with a transaction number stored previously.

4. The method according to claim 3, wherein the judging is executed based on whether or not the extracted transaction number is identical to the transaction number stored previously.

5. The method according to claim 3, wherein the judging is executed based on whether or not the extracted transaction number has been used for the first time.

6. A transaction document managing system, comprising:
a reading unit that reads a transaction document to which transaction number is attached;
an extracting unit that extracts the transaction number from the transaction document read by the reading unit; and
a judging unit that judges whether or not the read transaction document is valid, on a basis of the extracted transaction number.

7. The system according to claim 6, wherein:
the reading unit comprises a scanner section that reads the transaction document as an image, and
the extracting unit converts data read by the scanner section, into character data to extract the transaction number.

8. The system according to claim 6, wherein the judging unit comprises a comparing unit that compares the extracted transaction number with a transaction number stored previously.

9. The system according to claim 8, wherein the comparing unit comprises an identity judging unit that judges whether or not the extracted transaction number is identical to the transaction number stored previously.

10. The system according to claim 8, the comparing unit comprises a first-time judging unit that judges whether or not the extracted transaction number has been used for the first time.

11. A transaction document managing system comprising:
a branch office comprising:
a scanner section; and
a first computer; and
a center comprising a second computer, wherein;
the first computer, the scanner section, and the second computer are connected to each other via a network,
the scanner section reads a transaction document to which transaction number is attached, to generate image data of the transaction document,
the first computer comprises:
an extracting unit that extracts transaction number from the image data of the transaction document; and
a judging unit that compares the transaction number extracted by the extracting unit with transaction number generated by the second computer to judge whether or not the read transaction document is valid.
